(19) United States
(12) Patent Application Publication
(10) Pub. No.: US 2008/0046582 A1
(43) Pub. Date: Feb. 21, 2008

(54) SYSTEM, APPARATUS, AND METHOD FOR HANDLING AND REPRESENTING CONTEXT DATA IN A SERVICE COMPONENT ARCHITECTURE

(75) Inventors: Michael Beisiegel, Poughkeepsie, NY (US); Jean-Sebastien Michel Delfino, San Carlos, CA (US); Zhaohui Feng, Fremont, CA (US); Pamela Hung-Yin Fong, East Palo Alto, CA (US); Chi-Ming Yau, San Mateo, CA (US)

Correspondence Address: Kunzler & McKenzie, 8 EAST BROADWAY, SUITE 600, SALT LAKE CITY, UT, 84111, US

(73) Assignee: INTERNATIONAL BUSINESS MACHINES CORPORATION, ARMONK, NY (US)

(21) Appl. No.: 11/466,062

(22) Filed: Aug. 21, 2006

(51) Int. Cl. G06F 15/173; G06F 15/16

(52) U.S. Cl. 709/230; 709/226

(57) ABSTRACT

A program product and system are disclosed for receiving a transport message from an external service component by way of an external transport protocol. The transport message includes both primary data and context data. Once received, the primary data and context data are extracted from the transport message and translated into a format required by an SCA message. The primary data is then inserted into a body of the SCA message and the context data is implicitly inserted into a transmit header of the SCA message. The transmit header of the SCA message uses a universal format for carrying context data received over various different external transport protocols.

### BACKGROUND OF THE INVENTION

1. Field of the Invention

This invention relates to Service Component Architecture (SCA) and more particularly to methods for handling and representing context data in a Service Component Architecture.

2. Description of the Related Art

The Service Component Architecture (SCA) is a specification put forward by major software vendors with the objective of simplifying how organizations create and implement applications in a Service Oriented Architecture (SOA). SCA is included in the SOA Programming Model along with Service Data Objects (SDO), which allow heterogeneous data to be accessed and manipulated in a uniform manner.

An SCA is based on service components which may be configured to provide services, consume other services, or both. These service components may be packaged together with import components and export components into SCA modules, and communicate with one another using SCA messages. The import and export components define a module's external interfaces or access points. These import and export components typically require binding information, which specifies the means of transporting data to and from the SCA modules. For example, the import and export components of SCA modules may be used to access or provide services to external systems or services over various transport protocols, such as IIOP, HTTP, SOAP, and JMS.

The service interface between two communicating service components may require exchange of certain information. In addition, the runtime environments that execute the SCA components may need to exchange certain information related to the quality and expectations for the communications and/or service. This Quality of Service (QoS) data, referred to herein as context data, needs to be communicated in a manner that is efficient, does not disrupt the service calls, and allows use of the various different transport protocols. In the past, QoS data has been passed as part of the message sent via the transport protocol. Consequently, the format of the QoS data was highly protocol dependent.

Different transport protocols, such as those listed above, may use different formats or approaches for carrying context data. Such context data may be used to augment the primary data of a message by providing additional information about the contents of the message or information on how to handle or process the message itself. For example, context data could be used to fulfill quality of service (QoS) requirements for an incoming SCA message. In view of the foregoing, what is needed is a uniform way of representing context data in SCA messages exchanged over various protocols.

### SUMMARY OF THE INVENTION

The present invention has been developed in response to the present state of the art, and in particular, in response to the problems and needs in the art that have not yet been fully solved by currently available products and systems. Accordingly, the present invention has been developed to provide a program product for handling and representing context data in a Service Component Architecture. The program product includes a computer readable medium storing a computer-readable program that when executed on a computer causes the computer to receive, in an SCA runtime environment, a transport message from an external service component by way of an external transport protocol. The transport message includes both primary data and context data. The context data is provided by the external service component to fulfill a Quality of Service requirement.

Once received, the primary data and context data are extracted from the transport message and translated into an SCA header format. The primary data is then inserted into a body of the SCA message and the context data is inserted into a transmit header of the SCA message. The transmit header of the SCA message uses a universal format for carrying context data received from various different external transport protocols. The SCA message is then passed to a target SCA component.

In selected embodiments, the program product also causes the computer to receive, in another SCA runtime environment, an SCA message which includes primary data in the body of the message and context data in the transmit header of the message. The primary data and context data are then extracted from the SCA message and translated into a format required by an external transport protocol. The primary and context data are then inserted into a transport message conforming to the external transport protocol. The external transport protocols referred to above may include, for example, Internet Inter-Orb Protocol (IIOP), Hypertext Transfer Protocol (HTTP), Simple Object Access Protocol (SOAP) and Java Message Service (JMS).

In another embodiment in accordance with the invention, a system for handling and representing context data in a Service Component Architecture includes a service component in an SCA runtime environment and an export binding handler associated with the service component. The export binding handler is configured to receive and extract primary and context data from transport messages received over an external transport protocol. The export binding handler is further configured to insert the primary data into the body of an SCA message and the context data into the transmit header of the SCA message. The transmit header of the SCA message provides a universal format for implicitly carrying context data from various different external transport protocols.

In selected embodiments, the system may also include another service component in another SCA runtime environment. An import binding handler associated with this service component is configured to receive an SCA message, extract context data from the header of the SCA message and primary data from the body of the SCA message. The context data and primary data are then inserted into a message conforming to the external transport protocol. In selected embodiments, the import and export binding handler are components that are plugged into the SCA runtime environments. In this way, different binding handlers may be plugged into the SCA runtime environment as needed to handle different external transport protocols.

The present invention provides a novel program product and system for handling and representing context data in a Service Component Architecture. The features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through the use of the accompanying drawings, in which:

FIG. 1 is a high-level schematic block diagram of Service Component Architecture showing import and export modules for communicating with and interfacing with external components; and

FIG. 2 is a high-level schematic block diagram of a system for handling and representing context data in a Service Component Architecture.

### DETAILED DESCRIPTION OF THE INVENTION

Many of the functional units described in this specification have been represented as modules in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer program of a computer useable medium and useable by a computer as part of a computer program product program may take any form capable of causing execution of a program of machine-readable instructions on a digital processing apparatus. A computer readable medium may be embodied by random access memory, read only memory, flash memory, a transmission line, a compact disk, digital-video disk, a magnetic tape, a Bernoulli drive, a magnetic disk, a punch card, integrated circuits, custom VLSI circuits, gate arrays, or other digital processing apparatus memory devices or other devices capable of directing, modifying, or otherwise providing input to the processing of a digital processing apparatus.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

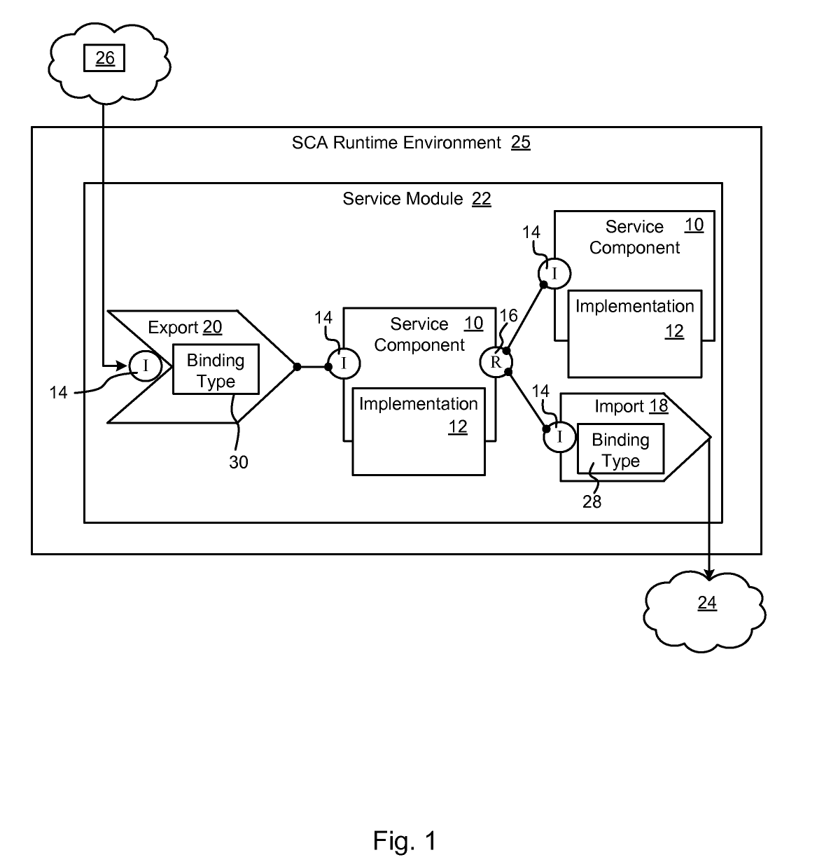

Referring to FIG. 1, a Service Component Architecture (SCA) is based on a service-oriented architecture and is designed to present business processes in a service-oriented manner. One primary objective of SCA is to separate business integration logic from implementation so that a developer can focus on integrating applications without worrying about the implementation details.

The building blocks in SCA are service components 10 which may be configured to provide services, consume other services, or both. Each service component 10 includes an implementation 12, which is hidden from the developer inside the component 10, and one or more interfaces 14, which define the component's inputs, outputs, and faults. A component 10 may also include one or more references 16, which identify the interface 14 of another service component 10 that a component requires or consumes. Because the service components 10 contain and hide an implementation 12, a developer can graphically assemble, or “wire,” the components 10 together without knowledge of low-level implementation details.

The SCA service components 10 may be packaged together with import and export components 18, 20 into SCA modules 22, which run in an SCA runtime environment 25. The import and export components 18, 20 define a module's external interfaces or access points. For example, an import component 18 may be used to reference external services 24 outside of a module 22, so they can be called from within the module 22. An export component 20 allows service components 10 to provide their services to external clients 26. For the purposes of this description, these external services 24 and clients 26 are referred to as external components 24, 26.

The import and export components 18, 20 typically require binding information, which specifies the means of transporting data to and from the SCA modules. For example, an import binding type 28 refers to the specific way an external service 24 is bound to an import component 18. This includes the transport protocol used to communicate between the external service 24 and the import component 18. An export binding type 30 describes the specific way a module's services are made available to a client 26, including the communication protocol used to communicate with the client 26. For example the import and export components 18, 20 may be used to access or provide services to external systems or services over various protocols, including but not limited to IIOP, HTTP, SOAP, and JMS. This can be accomplished by assigning, for example, a Web Service, EIS, JMS, or Stateless Session EJB binding type 28, 30 to an import or export component 18, 20.

Nevertheless, different protocols may use different formats or approaches for representing the context data needed to handle and process transport messages transmitted over the above-listed protocols. For purposes of this description, the phrase “context data” is used to refer to data used to augment the primary data, or payload, of a message by providing additional information about the contents of the message or information on how to handle or process the message. In particular, the context data refers to data required to meet Quality of Service (QoS) requirements made by a source service component. These QoS requirements may be set and enforced by the runtime environments involved in providing the desired service. Advantageously, the context data separates the QoS data from the main data involved in the service.

For example, a message containing a purchase order may include primary data, such as items to purchase, the customer, or financial information. However, a Web Service may require additional information to properly process the message, such as the purchase order's processing priority. In other cases, a Web service may require context information, such as a processing instruction, to determine how to process the message.

Examples of context data include security information. This may include message-level security or a digital signature associated with a credit card transaction. Context data may also include correlation identifiers indicating that a message is associated with a logical group of messages exchanged in a workflow. In other situations, context data may include transactional or reliability information that indicates the quality of service or priority required when processing messages.

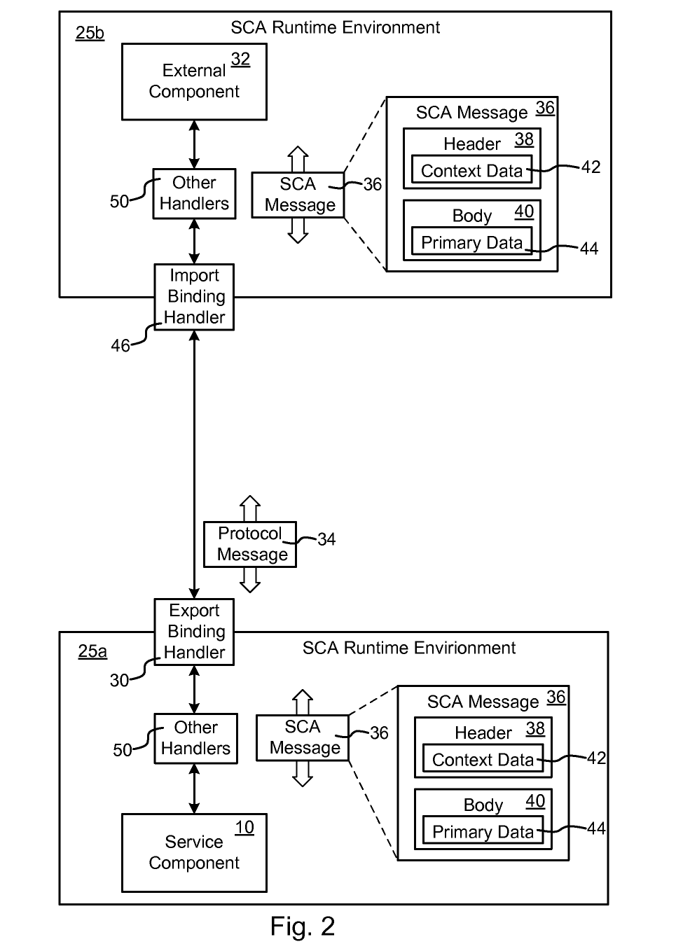

Referring to FIG. 2, in one embodiment, a system for handling and representing context data in SCA includes a service component 10 and an export binding handler 30 associated with the service component 10 in a first SCA runtime environment 25a. The export binding handler 30 acts as a translator between the service component 10 and an external component 32 by receiving protocol messages 34 (also referred to as transport messages 34) from the external component 32, extracting data from these protocol messages 34, and binding the data to the SCA communication protocol. The export binding handler 30 sends the protocol message 34 to the external component 32 (also referred to as the target SCA component 32). The SCA communication protocol uses SCA messages 36 for communicating between SCA components 10, 30, 32, 46. These SCA messages 36 include a header 38 and body 40.

Context data received by the export binding handler 30 over the external transport protocol may come in various different formats. For example, for Web Services, N context data may be passed as an extra parameter in a Web Service method, stored as metadata within the body of an XML document, or passed in a SOAP message header. Furthermore, different external transport protocols, such as IIOP, HTTP, SOAP, JMS, or the like, also use different techniques for transporting context data. This provides a challenge for SCA and Service Data Objects (SDO), one primary goal of which is to provide a uniform way for accessing and working on data. Thus, what is needed is a uniform way for representing and transporting context data in SCA messages 36.

In selected embodiments in accordance with the invention, context data 42 may be stored in a uniform format in the header 38 of an SCA message 36. In one embodiment, the header 38 comprises a transmit header 38. The transmit header 38 is a type of header formatted specifically to hold context data related to transmission of protocol messages 34. Context data 42 is data related to the communications and interactions between a service component 10 and an external component 32. Examples of context data 42 include quality of service parameters, login parameters, timing parameters such as timestamps relating to the transmission of messages, and the like.

Primary data 44, on the other hand, may be inserted into the body 40 of the SCA message 36. In certain embodiments, the context data 42 may be inserted implicitly into the header 38. Implicit insertion of context data means that the context data 42 is identified and inserted into the header 38 without specific instructions to communicate the context data 42 from an application developer. In this way, context data 42 may be inserted into an SCA message header 38 in a way that is hidden from application developers.

Alternatively, in certain embodiments, the system for handling and representing context data in SCA includes an Application Programming Interface (API) that enables a developer to specifically insert particular context data 42 into one or more headers 38 for an SCA message. The developer may desire to explicitly set the context data 42 in order to accomplish a certain task. Once the context data 42 and primary data 40 are set, an API call pass the context data by way of a parameter to an invoke call. An example call may be “(DataObject) service.invoke (<called Method>, <context data object>).get(0).

In addition, an API of the system may also make the context data 42 available to SCA components explicitly to a developer by way of a message context interface. For example, a MessageContextManager may be used by the component to retrieve the message context. Advantageously, certain handlers 50 are configured to place the context data 42 and/or primary data 40 in a local thread of the SCA runtime 25a such that source code references to the SCA message 36 retrieve the context data 42 explicitly.

An import binding handler 46 acts as a translator between an external component 32 and the service component 10. In one embodiment, an import binding handler 46 receives SCA messages 36 from the external component 32, extracts context data 42 and primary data 44 from the SCA messages 36, and binds the primary data and context to transport messages 34 complying with an external transport protocol. This may include translating the primary data and context data into a format required by the external transport protocol. For the sake of illustration, the import binding handler 46 and export binding handler 30 are shown in different SCA runtime environments 25a, 25b. Nevertheless, in other embodiments, the import and export binding handlers 30, 46 may be located in the same SCA runtime environment.

In addition to the import and export binding handlers 30, 46, other handlers 50 may be configured to operate on the context data in SCA messages 36. For example, qualifier or header extension handlers 50 may be added to the SCA runtime environment to add, remove, update, or read context headers of SCA messages 36. In selected embodiments, certain handlers 50, such as a header handler 50, may be triggered by the presence of related metadata in SCA messages 36.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A program product for handling and representing context data in a service component Architecture (SCA), the program product comprising a computer readable medium storing a computer-readable program that when executed on a computer causes the computer to:
receive, in an SCA runtime environment, a transport message from an external service component by way of an external transport protocol, the transport message comprising primary data and context data provided by the external service component to fulfill a Quality of Service requirement;
extract the primary data and context data from the transport message;
translate the context data into an SCA header format;
insert the primary data into a body of a first SCA message;
insert the context data into a transmit header of the first SCA message, the transmit header having a universal format for carrying context data received from various external transport protocols;
passing the SCA message to a target SCA component.

2. The program product of claim 1, further comprising:
receiving, in the SCA runtime environment, a second SCA message comprising primary data in a body of the second SCA message and context data in a header of the SCA message;
extracting the primary data and context data from the second SCA message;
translating the primary data and context data into a format required by the external transport protocol; and
inserting the primary data and context data into a transport message conforming to the external transport protocol.

3. The program product of claim 1, wherein the external transport protocol is selected form the group consisting of IIOP, HTTP, SOAP and JMS.

4. A system for handling and representing context data in a Service Component Architecture (SCA), the system comprising:
a first service component in a first SCA runtime environment;
an export binding handler associated with the first service component, the export binding handler configured to receive and extract primary data and context data from transport messages received over an external transport protocol;
the export binding handler further configured to insert the primary data and context data into an SCA message, the SCA message comprising both a transmit header and a body, the context data provided by an external service component to fulfill a Quality of Service requirement; and
the export binding handler further adapted to insert the primary data into the body of the SCA message and the context data into a transmit header of the SCA message, the transmit header comprising a universal format for implicitly carrying context data from a plurality of different external transport protocols.

5. The system of claim 4, further comprising a second service component in a second SCA runtime environment, and an import binding handler associated with the second service component, the import binding handler configured to receive an SCA message, extract context data from a transmit header of the SCA message and primary data from a body of the SCA message, and insert the context data and primary data into a transport message conforming to the external transport protocol.

6. The system of claim 5, wherein the export binding handler is an SCA component plugged into the first SCA runtime environments and the import binding handler is an SCA component plugged into the second SCA runtime environment.

7. The system of claim 4, wherein the external transport protocol is selected form the group consisting of IIOP, HTTP, SOAP and JMS.

8. The system of claim 4, wherein the first SCA runtime environment is configured to explicitly expose one of the context data and the primary data to developer source code in response to Application Programming Interface (API) calls.

9. The system of claim 4, wherein the first SCA runtime environment is configured to explicitly pass the context data to an external component as part of an SCA message.
